(19) United States
(12) Patent Application Publication
(10) Pub. No.: US 2007/0248792 A1
(43) Pub. Date: Oct. 25, 2007

(54) Extruded honeycombed panel with high mechanical strength

(75) Inventor: Cosimo Conterno, Beregazzo Con Figliaro (Como) (IT)

Correspondence Address: HEDMAN & COSTIGAN P.C., 1185 AVENUE OF THE AMERICAS, NEW YORK, NY, 10036, US

(73) Assignee: PolitecPolimeriTecniciSA

(21) Appl. No.: 11/371,824

(22) Filed: Mar. 9, 2006

(51) Int. Cl. B32B 3/12

(52) U.S. Cl. 428/116

(57) ABSTRACT

An extruded honeycombed panel with high mechanical strength made from synthetic thermoplastic material comprises at least two flat sheets (13) that are parallel to each other, spaced apart and connected by a plurality of longitudinal ribs (14) that are incident with respect to the at least two sheets (13), which are suitable for defining at least one layer of said panel, in which the ribs (14) belonging to at least one layer of the panel have an undulating longitudinal extension.

The present invention refers to an extruded honeycombed panel with high mechanical strength, in particular for the field of construction.

Extruded honeycombed panels made from thermoplastic material are used to form roofs and/or buffer walls in the building industry, for example for prefabricated products, or in the agricultural field, for example for greenhouses.

The panels, generally but not exclusively made from polycarbonate, have a honeycombed structure with internal ribs extending longitudinally and rectilinearly.

Such a structure gives known panels excellent mechanical strength against stresses applied longitudinally, but insufficient mechanical strength against mechanical stresses applied transversally.

This has a great impact upon the installation costs of the panels, which, after being cut into suitable sized sheets, are assembled together through joining elements to form a wall, a roof or other.

Indeed, to avoid flexing in the transversal direction it is necessary to greatly limit the maximum size of the sheets between the joining elements.

From this there derives an increase in installation costs, a greater complexity of such constructions and a worse aesthetic result.

Moreover, for some applications such as greenhouses, or in any case when it is desired to allow light pass into the structure formed from the panels, it is extremely important that there is optimised passage of light, in other words a good diffusion of light screening the direct passage of the sun's rays, through the panels, in this case obviously made from transparent material.

So to screen the sun's rays the panels are usually coated externally with pigments and additives contained in the mass of the material, which reduce the direct transmission of light whilst excessively penalising the diffusion factor.

The purpose of the present invention is that of making an extruded honeycombed panel with high mechanical strength both against stresses acting longitudinally and against stresses acting transversally.

Another purpose of the present invention is that of making a panel that ensures excellent passage of light into the enclosed areas.

Another purpose of the invention is that of making an extruded honeycombed panel that is particularly simple and functional, with low costs.

These purposes according to the present invention are accomplished by making an extruded honeycombed panel as outlined in claim 1.

Further characteristics are foreseen in the dependent claims.

Further characteristics and advantages of an extruded honeycombed panel according to the present invention shall become clearer from the following description, given as an example and not for limiting purposes, referring to the attached schematic drawings, in which:

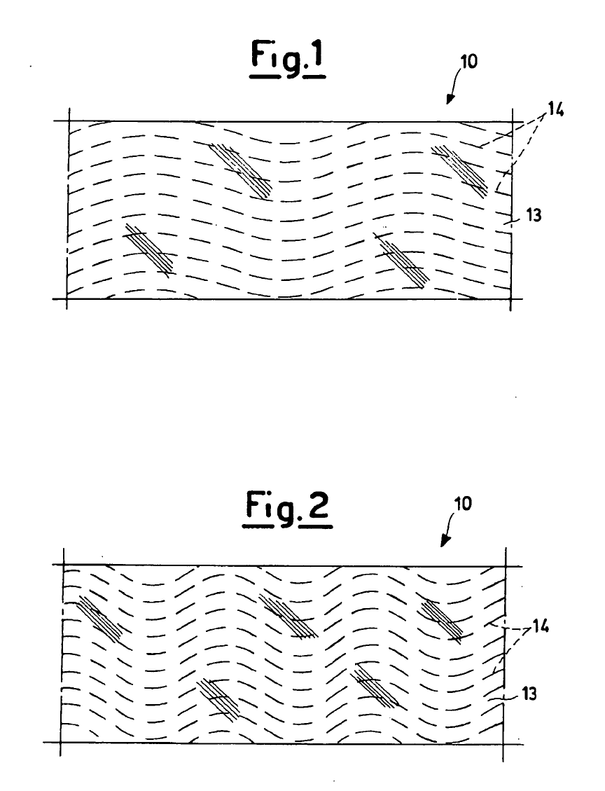

FIGS. 1 and 2 are plan views of two possible embodiments of an extruded honeycombed panel with high mechanical strength according to the present invention;

FIGS. 3 to 5 schematically show three possible cross sections of a honeycombed panel according to the invention;

FIGS. 6 and 7 are perspective views of partially separated details of further extruded honeycombed panels according to the invention.

With reference to the figures, an extruded honeycombed panel 10 is shown, in particular for application as roofs and/or buffer walls in the construction industry, for example for prefabricated products or for greenhouses.

The honeycombed panel 10 made from thermoplastic material comprises two or more flat sheets 13 that are parallel to each other, spaced apart and connected by a plurality of ribs 14 that are incident with respect to such sheets 13.

The extruded honeycombed panels 10 can be made up of just two sheets 13 that define a layer or else they can comprise a greater number of overlapping layers.

In the case of a single-layer panel, shown schematically in FIG. 3 in cross section, according to the invention all of the ribs 14, parallel to each other, have an undulating longitudinal extension that, as shown as an example in plan in FIGS. 1 and 2, can be more or less accentuated.

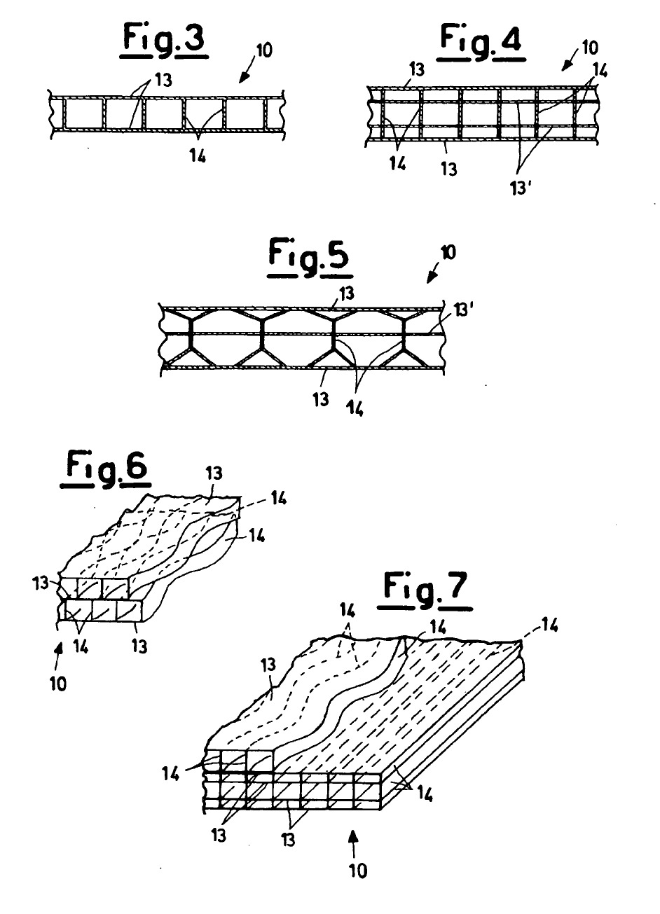

FIG. 4 shows, as an example, a cross section of a panel 10 made up of many layers, in which, according to a preferred embodiment, the sheets inside the panel 13′ are thinner than the outer sheets 13.

FIG. 5, on the other hand, shows a cross section of a multi-layer panel in which the ribs 14 are not incident with the outer sheets 13 at a right angle, but rather are arranged inclined with respect to them.

FIGS. 4 and 5 shows just a few examples of multi-layer panels, which nevertheless can have other structures, even more complex ones, that are known to the man skilled in the art.

In the multi-layer configurations the ribs 14 of a first layer of the panel 10 can, for example, have a different undulating longitudinal extension to the undulating longitudinal extension of the ribs 14 of a second layer, as shown in the separated detail of FIG. 6, in which the ribs of the two contiguous layers are also arranged in positions staggered from each other.

Moreover, in the multi-layer panels 10 according to the present invention it is sufficient for the ribs 14 of a single layer to have an undulating longitudinal extension.

As shown in FIG. 7, in a further embodiment of the panel 10 according to the present invention, the ribs 14 of a first layer can have undulating longitudinal extension and the ribs of the underlying layers can have a rectilinear longitudinal extension.

The arrangement in the panel 10 of at least one layer of ribs with undulating longitudinal extension increases the rigidity of the structure in the transversal direction to an increasing extent the more accentuated is the undulated profile of the ribs. In such a way, indeed, the ribs are more distributed on the surface avoiding the presence of longitudinal portions or channels without reinforcement ribs and subject to bending.

The honeycombed structure can be made from polycarbonate, or else other transparent or opaque synthetic materials, e.g. alloys of thermoplastic materials with similar chemical-physical characteristics to polycarbonate.

In the case of extruded honeycombed panels made from transparent materials, the presence of the ribs with undulating extension determines the diffusion of the light rays through the panel at the same time preventing it from crossing it directly.

Indeed, the sun's rays that strike the panel 10 at a rib 14 shall be diffused, whereas at the honeycomb, in other words in the portion between two ribs 14, direct crossing is possible. In the extruded honeycombed panel 10 according to the invention the ribs 14 are more distributed on the surface of the panel and the sun's rays shall never meet an entire longitudinal portion without ribs 14 to be crossed, but shall be diffused by them.

It is therefore advantageously possible to forgo applying an outer screen of pigments to the panels to screen the sun's rays, which substantially reduces the transmission of light.

The extruded honeycombed panel object of the present invention has the advantage of having improved the characteristics of mechanical strength in the transversal direction maintaining a simple and light structure.

The extruded honeycombed panel according to the present invention, made from transparent material advantageously has an excellent light diffusion factor.

When used as a heat exchanger the extruded honeycombed panel object of the present invention has the advantage of prolonging the flow times of the fluids promoting heat exchange.

The extruded honeycombed panel with high mechanical strength thus conceived is susceptible to numerous modifications and variants, which are all covered by the invention itself; moreover, all of the details can be replaced with technically equivalent elements. In practice, the materials used, as well as their sizes, can be whatever according to the technical requirements.

1. Extruded honeycombed panel with high mechanical strength made from synthetic thermoplastic material comprising at least two flat sheets (13) that are parallel to each other, spaced apart and connected by a plurality of longitudinal ribs (14) that are incident with respect to said at least two sheets (13), said at least two sheets (13) being suitable for defining at least one layer of said panel, characterised in that ribs (14) belonging to at least one layer of said panel have an undulating longitudinal extension.

2. Panel according to claim 1, characterised in that it comprises three or more of said parallel flat sheets (13, 13′) suitable for defining at least two layers of said panel carrying longitudinal ribs (14) that are incident with respect to said sheets (13, 13′).

3. Panel according to claim 2, characterised in that said ribs (14) of a first layer of said panel have a different undulating longitudinal extension to the undulating longitudinal extension of ribs (14) of a second layer of said panel.

4. Panel according to claim 2, characterised in that said ribs (14) of a first layer are in staggered position with respect to said ribs (14) of a second layer.

5. Panel according to claim 1, characterised in that said synthetic thermoplastic material is transparent.

6. Panel according to claim 1, characterised in that said synthetic thermoplastic material is polycarbonate.
